(19) United States
(12) Patent Application Publication
(10) Pub. No.: US 2012/0043284 A1
(43) Pub. Date: Feb. 23, 2012

(54) OIL SKIMMER

(76) Inventor: JAMES H. PAULK, MOSS POINT, MS (US)

(21) Appl. No.: 13/010,575

(22) Filed: Jan. 20, 2011

Related U.S. Application Data
(60) Provisional application No. 61/401,644, filed on Aug. 17, 2010.

(51) Int. Cl. C02F 1/40

(52) U.S. Cl. 210/776; 210/136

(57) ABSTRACT

A method and system for skimming oil contaminated water with a vessel fitted with a rotating reel and receiver tank affixed to a frame that can be raised or lowered into a body of water for flinging contaminated water into the receiver tank that will be fitted with check valves at the bottom of the receiver tank for discharge of water back into the body of water while pumping out oil from the top of the receiver tank into storage.

This application claims priority from U.S. Provisional application Ser. No. 61/401,644 (“the '644 application”) filed Aug. 17, 2010. The '644 application is incorporated herein by reference.

### BACKGROUND OF THE INVENTION

This invention relates to methods and equipment for skimming oil and other contaminants from water contaminated by an oil spill or other discharge and more particularly, the invention relates to a device mounted on a floating vessel or barge that is adjustable to the draft of the vessel and the depth and location of the oil and contaminants in the water. In addition the invention will extract water from the skimmed oil and contaminants, making the oil more valuable as a retrieved product.

Numerous methods and devices have been tried to deal with the spillage of oil and other contaminants into a body of water but none are efficient in the extraction of oil from the water that has been contaminated. It is possible to suck or vacuum large quantities of oil contaminated water into a containment vessel, but the oil must eventually be extracted from the water to be reclaimed as a usable product.

### SUMMARY OF THE INVENTION

It is an object of this invention to provide a system that will skim oil contaminated water, remove the water for return to the body of water being skimmed, and separate the oil and contaminants for efficient retrieval as valuable water-free product.

It is an object of this invention to provide a system for skimming oil contaminated water comprising a vessel fitted with a rotating reel and receiver tank affixed to a frame that can be raised or lowered into a body of water for flinging contaminated water into the receiver tank that will be fitted with check valves at the bottom of the receiver tank for discharge of water back into the body of water while pumping out oil from the top of the receiver tank into storage.

It is an object of this invention to provide a method for skimming oil contaminated water comprising the steps of; providing a vessel fitted with a rotating reel and receiver tank fitted with check valves at the bottom of the receiver tank, affixed to a frame that can be raised or lowered into a body of water; lowering the rotating reel and receiver tank into a body of water contaminated with oil; rotate the reel and fling the contaminated water into the receiver tank; discharge the water back into the body of water; and pump out oil from the top of the receiver tank into storage.

### BRIEF DESCRIPTION OF THE DRAWINGS

FIG. 1 is a plan view of the inventive oil skimmer system.

FIG. 2 is a longitudinal cross section of the inventive oil skimmer system taken in the direction of arrows 2-2 on FIG. 1 with the reel and receiver tank lifted.

FIG. 2a is a longitudinal cross section of the inventive oil skimmer system taken in the direction of arrows 2-2 on FIG. 1 with the reel and receiver tank lowered to skim the surface of the water.

FIG. 3 is a perspective view of the reel and receiver tank in their relative positions without support structure being shown.

### DETAILED DESCRIPTION OF THE INVENTION

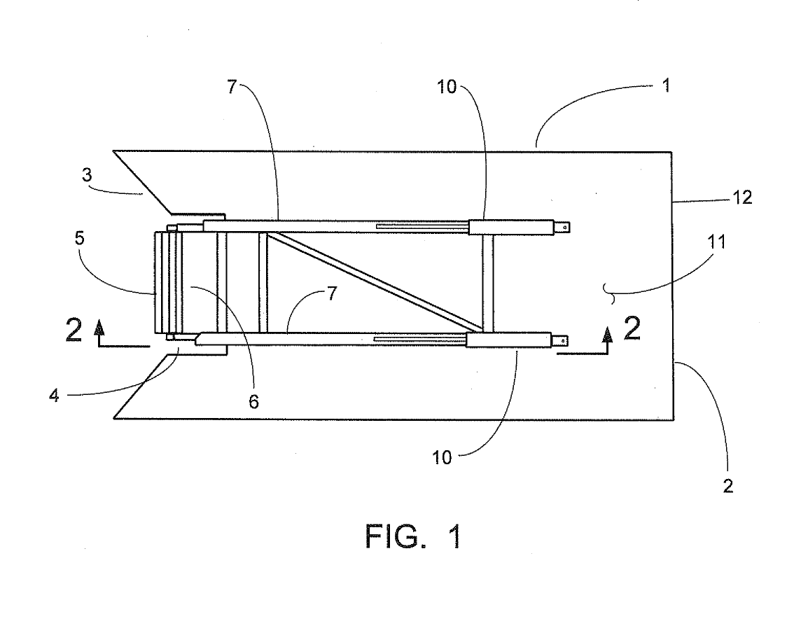

In FIG. 1, a plan view of the inventive oil skimmer system 1 is depicted comprising a barge 2 with a concave configured bow 3 and notch 4 for placement of a reel 5 and receiver tank 6. In FIG. 1, a frame 7 with a forward end 8 and aft end 9 for lowering and raising a reel 5 and receiver tank 6 on the forward end 8 of the frame 7 are shown along with the rams 10 for raising and lowering the frame 7 above the deck 11 of the barge. The stern 12 of the barge 2 is also shown and it is understood that the barge 2 could be self propelled or propelled by a suitable tug or tow boat to engage oil contaminated water. As an alternative, the barge could be held in place and oil contaminated water channeled into the concave bow 3 with oil booms or other means.

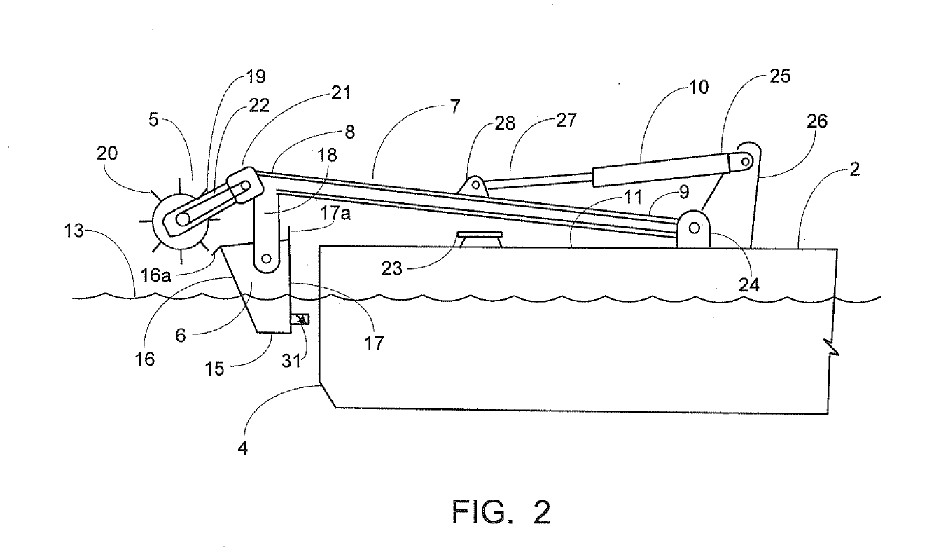

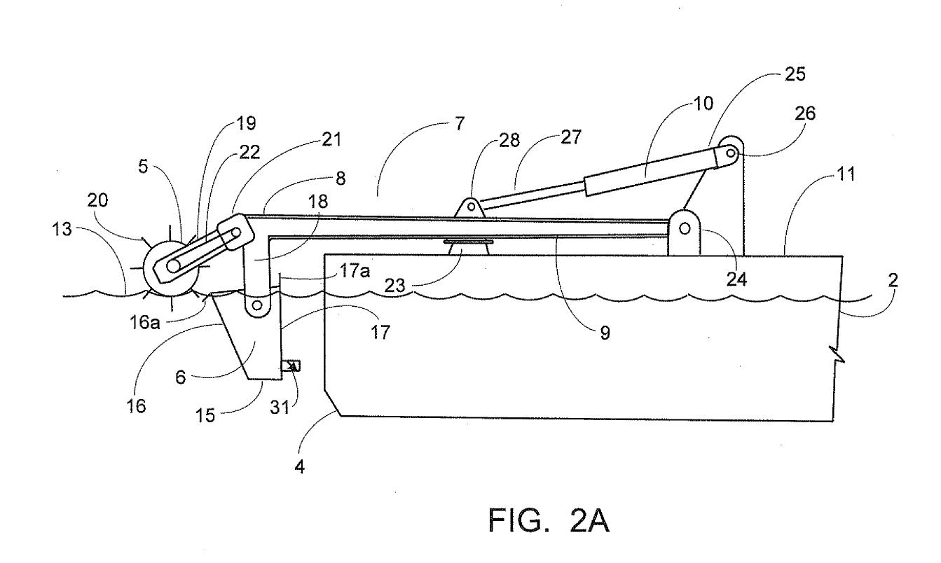

FIG. 2 shows a longitudinal cross section of the inventive oil skimmer system 1 taken in the direction of arrows 2-2 on FIG. 1. In this depiction, the reel 5 and receiver tank 6 are shown in position at the forward end 8 of the frame 7 and lifted above the water surface 13. The receiver tank 6 has an open top 14, a bottom 15, a front 16, a forward tapered lip 16a, a back, 17 and a lip 17a extending above the open top 14 from the back 17. The receiver tank 6 is suspended from a tank support beam 18 rigidly attached to the forward end 8 of the frame 7. Also rigidly attached to the forward end 8 of the frame 7 is a reel support beam 19. It is intended that the reel 5 will rotate and the axis of rotation will be parallel to the front 16 of the receiver tank 6. The reel 5 will have a plurality of blades 20 to fling oil contaminated water into the open top 14 of the receiving tank 6, when the reel 5 and receiving tank 6 are lowered on the frame 7 to engage the oil contaminated water as shown in FIG. 2a. A reel drive motor 21 and chain 22 are shown as indicative of a means for powering the reel 5, but the reel 5 could be powered in alternative drive configurations. As shown, the reel 5 would be positioned forward of the receiving tank 6.

In FIG. 2a, the reel 5 and receiver tank 6 on the forward end 8 of the frame 7 have been lowered such that the reel 5 can skim the surface of the water 13 and fling the contaminated water into the open top 14 of the receiver tank 6. In this position, the frame is shown as resting on a support pad 23. It is intended that this support pad 23 be vertically adjustable to accommodate different positions for the reel 5 and receiver tank 6 in keeping with the draft of the barge 2. It is also intended that the frame 7 be fitted with a locking device to hold it in place as well as a ratcheting lock device to prevent the receiver tank 6 from floating up when being lowered into position into the water.

As seen in FIGS. 2 and 2a, the aft end 9 of the frame 7 would be pivoted on suitable brackets 24 mounted on the deck 11 of the barge 2. Likewise, the rams 10 for raising and lowering the frame 7 would be pivotally mounted on an aft end 25 on a suitable bracket 26 on the deck 11 of the barge 2 while the forward end 27 of the rams 10 would be pivotally mounted to the frame 7 by a suitable bracket 28. Although not shown, it is understood that the rams 10 would be provided with a power source whether it be hydraulic or pneumatic.

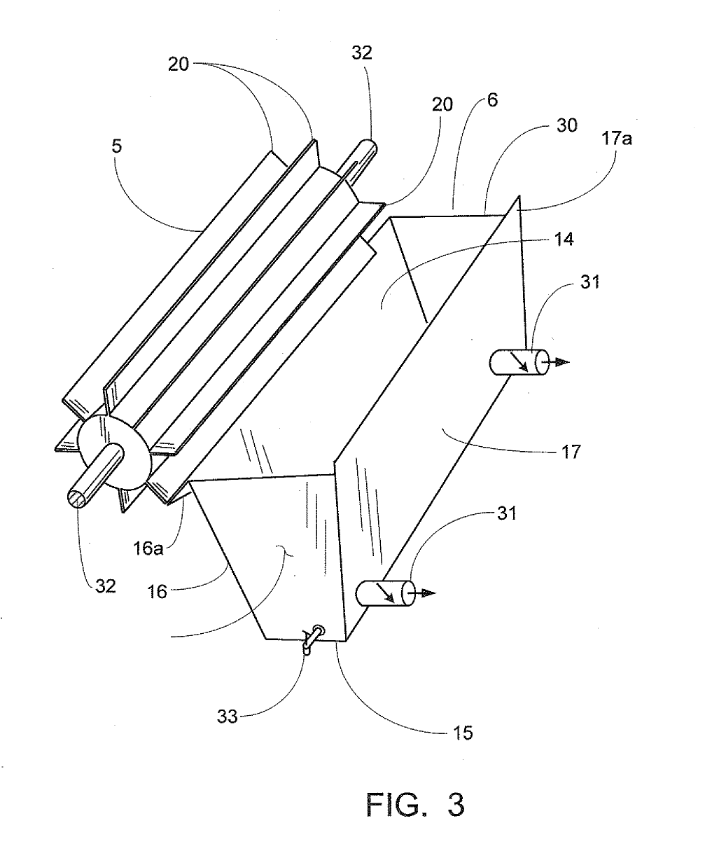

A perspective view of the reel 5 and receiver tank 6 in their relative positions without the tank support beams 18, reel support beams 19 and the frame 7 is shown in FIG. 3. The open top 14, bottom 15, front 16, forward tapered lip 16a, back 17, left side 29, right side 30 and lip 17a of the receiver tank 6 are shown. It is intended that the upper edge of both the left side 29, right side 30 be tapered as shown to prevent fluids in the receiver tank 6 from sloshing out. Also shown is at least one check valve 31 on the back 17 of the receiver tank 6 at or near the bottom 15. The check valves 31 will be positioned to only allow flow out of the receiver tank 6. A drain value 33 is also shown.

Also shown in FIG. 3, the reel 5 is positioned such that its rotation will fling water into the open top 14 of the receiver tank 6. As shown, the longitudinal axis of the reel 5 is parallel to the front 16 of the receiver tank 6. A reel drive shaft 32 is depicted and it is understood that the drive shaft 32 will be turned by a reel drive motor 21, either directly or through a power linkage such as a chain or belt, none of which are shown in FIG. 3. It is also understood that the reel 5 can be easily constructed from a tubular member such as pipe with blades 20 attached to the outside of the tubular member.

When in operation, with the reel 5 and receiver tank 6 in position at the surface of contaminated water, the reel 5 will rotate in a direction causing the contaminated water to fly or be flung into the open top 14 of the receiver tank 6. As the receiver tank 6 fills, the oil will stay at the top of the liquid in the receiver tank 6 and the water will sink to the bottom of the receiver tank 6 where it will be discharged through the one way check valves 31 back into the body of water. While discharging relatively clean water back into the body of water, the relatively pure oil floating in the upper part of the receiver tank 6 can be pumped out into a holding tank either on board the barge or in a standby storage vessel.

Although not shown, it is also understood that the receiver tank 6 will be fitted with a fathometer or optical sight gauge to monitor the levels of liquids in the receiver tank 6 during skimming operation.

As approximate dimensions, it is suggested that the open top of the receiver tank 6 be 10′ wide by 4′ deep, and the vertical height be 4′. The reel 5 would be approximately 8′ long to accommodate the width of the main beams of the frame 7. It is also suggested that the total length of the frame 7 be approximately 20′ with 6″ I beams as primary members although a length as small as 11′ would suffice. In practice, however, the dimensions can be reduced as needed to suit the application and a reel 5 no longer than 2′ would suffice. Likewise, it is suggested that the system, particularly the frame 7 be assemble with bolts or pins, allowing easy assemble and disassembly. While it is suggested that the components be manufactured from structural steel, other materials such as aluminum would be suitable. It is understood that the invention could be made to any size compatible with its operation.

I claim:

1. A system for skimming oil contaminated water, removal of the water for return to the body of water being skimmed, and separation of the oil and contaminants for efficient retrieval as valuable water-free product comprising a vessel with a bow, a stern and a deck fitted with a rotating reel powered by a reel drive motor with a plurality of blades and a receiver tank having an open top with a front side, a back side, a left side and a right side, a bottom with check valves, a front and a back, said rotating reel having an axis of rotation parallel to the open top of said receiver tank and positioned forward of the receiver tank to fling water into the open top of the receiver tank, with both the reel and receiver affixed to a frame pivotally mounted to the deck of the vessel whereby said reel and receiver can be raised and lowered into a body of water for flinging contaminated water into the receiver tank and discharging water back into the body of water through the check valves while pumping out oil from the open top of the receiver into storage.

2. The system of claim 1 where the vessel has a concave configured bow and notch for placement of the rotating reel and receiver tank.

3. The system of claim 1 where the receiver tank further comprises a forward tapered lip at the front side of the open top, and a lip at the back side of the open top, and the left side and right side of the receiver tank have a tapered upper edge to prevent fluids from sloshing out of the open top of the receiver tank.

4. The system of claim 2 where the receiver tank further comprises a forward tapered lip at the front side of the open top, and a lip at the back side of the open top, and the left side and right side of the receiver tank have a tapered upper edge to prevent fluids from slashing out of the open top of the receiver tank.

5. The system of claim 1 where the frame would rest on a support pad when the reel and receiver were in position in a body of water and said support pad would be vertically adjustable to accommodate different positions of the reel and receiver in keeping with the draft of the vessel.

6. The system of claim 2 where the frame would rest on a support pad when the reel and receiver were in position in a body of water and said support pad would be vertically adjustable to accommodate different positions of the reel and receiver in keeping with the draft of the vessel.

7. The system of claim 3 where the frame would rest on a support pad when the reel and receiver were in position in a body of water and said support pad would be vertically adjustable to accommodate different positions of the reel and receiver in keeping with the draft of the vessel.

8. The system of claim 4 where the frame would rest on a support pad when the reel and receiver were in position in a body of water and said support pad would be vertically adjustable to accommodate different positions of the reel and receiver in keeping with the draft of the vessel.

9. A method for skimming oil contaminated water, removal of the water for return to the body of water being skimmed, and separation of the oil and contaminants for efficient retrieval as valuable water-free product comprising the steps of;
providing a vessel with a concave configured bow and notch, a stern and a deck, and fitted with a rotating reel powered by a reel drive motor with a plurality of blades, a receiver tank having an open top with a front side, a back side, a left side and a right side, a bottom with check valves, a front and a back, said rotating reel having an axis of rotation parallel to the open top of said receiver tank and positioned forward of the receiver tank to fling water into the open top of the receiver tank, with both the reel and receiver affixed to a frame pivotally mounted to the deck of the vessel;
positioning said vessel in oil contaminated water;
lowering said reel and receiver and power said reel to fling contaminated water into the receiver tank and discharge water back into the body of water through the check valves while pumping out oil from the open top of the receiver into storage.

10. The method of claim 10 further comprising the step of propelling the vessel to engage the contaminated water.
